(19) United States
(12) Patent Application Publication
(10) Pub. No.: US 2025/0113422 A1
(43) Pub. Date: Apr. 3, 2025

(54) System for Automatic Illumination of a Wearable Device

(71) Applicant: Apple Inc., Cupertino, CA (US)

(72) Inventors: Andrew K. McMahon, Redwood City, CA (US); Fletcher R. Rothkopf, Los Altos, CA (US)

(21) Appl. No.: 18/814,061

(22) Filed: Aug. 23, 2024

Related U.S. Application Data
(60) Provisional application No. 63/586,661, filed on Sep. 29, 2023.

(51) Int. Cl. H05B 47/11; H05B 47/115

(52) U.S. Cl. CPC H05B 47/11; H05B 47/115

(57) ABSTRACT

Intelligently illuminating an environment includes receiving, at a head mounted device, information indicative of ambient lighting conditions in the environment. In accordance with a determination that the ambient lighting conditions do not satisfy a brightness criterion, one or more first illuminators on the head mounted device are activated to project light in a first spectrum. While the one or more first illuminators are activated, image data of the environment is captured. A region of interest is determined in the environment based on the captured image data, and a second one or more illuminators are activated to project light in a visible light spectrum different than the first spectrum.

### FIELD OF THE INVENTION

This disclosure relates generally to illumination. More particularly, but not by way of limitation, this disclosure relates to techniques and systems for monitoring a physical environment and triggering illumination in eyewear in response to the context in the physical environment.

### BACKGROUND

Certain activities can be difficult if performed in a particular environment. For example, watching screens in a dark room, reading in the dark, and the like may be problematic for a person trying to perform these activities. According to some embodiments, a user navigating an environment may have difficulty in low light conditions.

In addition, simply turning on an overhead light may be an undesirable solution. For example, other people in the environment may be bothered by the light. Further, an overhead light may be too bright for user activity. Accordingly, improvements are needed for intelligent illumination.

### BRIEF DESCRIPTION OF THE DRAWINGS

FIG. 1 shows a diagram of an environment in which variations of the disclosure are utilized, according to one or more embodiments.

FIG. 2 shows a flow diagram of a technique for managing an operation of a device to intelligently activate illuminators, according to one or more embodiments.

FIG. 3 shows, in flowchart form, an example process for an illumination operation based ambient light conditions, in accordance with one or more embodiments.

FIG. 4 shows, in flowchart form, an example process for performing an illumination operation based on ambient light conditions and an object of interest, in accordance with one or more embodiments.

FIG. 5 shows, in block diagram form, an example network diagram, according to one or more embodiments.

FIG. 6 shows, in block diagram form, a mobile device in accordance with one or more embodiments.

### DETAILED DESCRIPTION

In general, embodiments described herein are directed to a technique for adjusting a lighting operation of a device in response to detected environmental conditions. In some embodiments, illuminators on a device and/or remotely from a device can be activated in response to conditions such as ambient light, objects of interest, predefined mapping information, and the like.

According to one or more embodiments, the lighting operation is performed by a low-power device, and is designed to require minimal power or other resources. For example, the device may be a wearable device, such as a head mounted device, which is intended to be worn for long periods, and thus may be power constrained. Because the device may be power constrained, the device may rely on low-power sensors, such as ambient light sensors, and may illuminate strategically, such as only in a determined direction or only when it is determined that lighting conditions do not satisfy a brightness criterion.

According to one or more embodiments, a head mounted device or other wearable device may be donned by a user. The head mounted device may include illuminators which are activated intelligently based on characteristics of the surrounding environment, such as ambient light determined by sensor data collected by an ambient light sensor. In some embodiments, the wearable device may include illuminators which, when activated, illuminate the surrounding environment using light in a first spectrum which may not be visible to a user, such as infrared light. An image may be captured of the environment while the illuminators are activated. The device may determine, based on the image data, a region of interest in the environment. The device may then activate one or more additional illuminators in a visible light spectrum toward the region of interest such that the region of interest becomes visible, or increases in visibility, to the user. For example, the device may include a see-through display through which the real environment is visible to the user as-is. That is, in contrast to a pass-through display in which a camera feed of the environment is captured and presented to the user as image data, the see-through display allows the user to view the actual physical environment through the see-through display. Accordingly, by illuminating the region of interest in the environment, the physical components of the environment become more visible to the user's eye.

In one or more embodiments, the system can intelligently illuminate an environment to bring attention to obstructions or unexpected objects in a physical environment. For example, the device may have access to predefined mapping data of a physical environment, such as a point cloud or other geometric representation of the environment. A determination can be made as to whether the environment includes an object of interest. The object of interest may include, for example, an obstruction in the vicinity of the user as indicated by the mapping data, or an object or obstruction in the vicinity of the user which is not identified in the mapping data and therefore is unexpected. The device may trigger illuminators toward the object of interest to bring attention to the object of interest.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, it being necessary to resort to the claims in order to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not necessarily be understood as all referring to the same embodiment.

It will be appreciated that, in the development of any actual implementation (as in any software and/or hardware development project), numerous decisions must be made to achieve a developer's specific goals (e.g., compliance with system-and business-related constraints) and that these goals may vary from one implementation to another. It will also be appreciated that such development efforts might be complex and time-consuming but would nevertheless be a routine undertaking for those of ordinary skill in the design and implementation of multi-modal processing systems having the benefit of this disclosure.

Various examples of electronic systems and techniques for using such systems in relation to various technologies are described.

A physical environment, as used herein, refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust the characteristic(s) of graphical content in the XR environment in response to representations of physical motions (e.g., vocal commands).

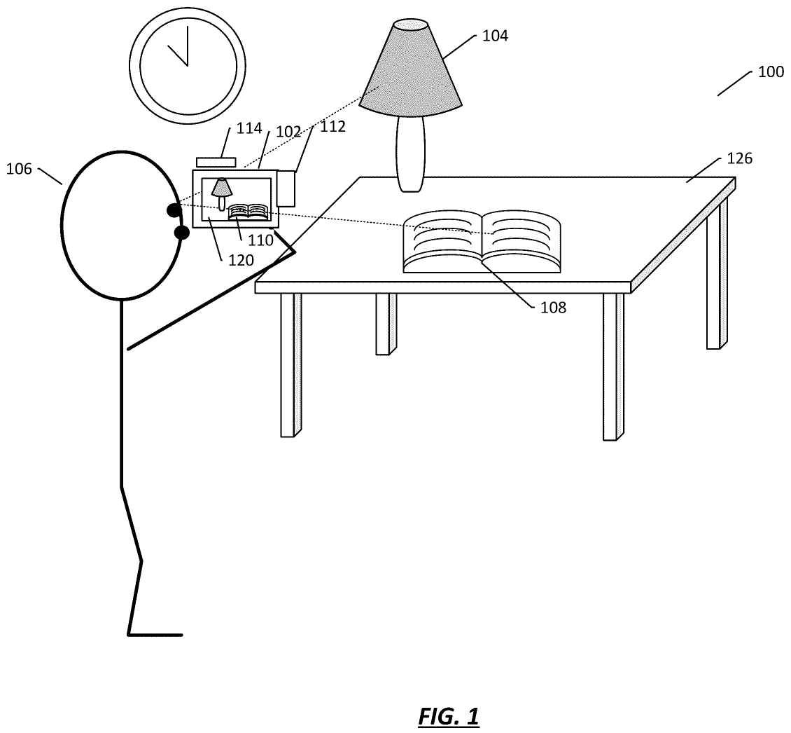

Turning to FIG. 1, an example environment diagram is presented, in accordance with one or more embodiments. According to some embodiments, a user 106 may view an environment 100 through a device 102. The device 102 may include a see-through display 120, by which the user 106 can see objects in the environment, as shown at 122. Accordingly, the lamp 104 and book 108 are visible via the see-through display 110.

In some embodiments, the device 102 may include various sensors by which sensor data for the environment and/or the user can be obtained. The sensors may be facing any direction. For example, the sensors 114 may include ambient light sensors, motion detection sensors such as inertial detection sensors, microphones, flicker sensors, image capture sensors, and the like. The ambient light sensor may include a sub-system for measuring and reporting the ambient light level (ALS) including relative levels of different wavelength/bands of visible light. The sensors 114 may additionally include a motion detection sensor, such as a gyroscope, accelerometer, or the like which is configured to measure the rotation and/or head-pose of the user. The image capture sensors may include one or more cameras situated on the device to capture image data of a view in front of the user. In some embodiments, the device 102 may include network connectivity by which the device can control functionality of other devices in the environment. This may include, for example, Wi-Fi signals, Bluetooth connections, pairing signals, and the like.

According to one or more embodiments, the device 102 may communicably couple to one or more remote devices in the environment and may obtain additional environmental data from the remote devices. The remote devices may include, for example, additional electronic devices, laptops, desktop computers, Internet of Things (IoT) devices, such as thermostats, smart lighting, such as lamp 104, and other devices. As such, in some embodiments, the device 102 can aggregate environmental data and/or functionality from multiple devices.

In one or more embodiments, the device 102 may include one or more illuminators 112 which are activated intelligently based on characteristics of the surrounding environment, such as ambient light determined by sensor data collected by sensors 114. The illuminators may include one or more light-source(s) and optical elements for controlling the spread and direction of the light output as well as it's perceived color. In some embodiments, the wearable device may include illuminators which are capable of producing light in different spectrums. For example, the illuminators may produce light in a first spectrum not visible to user 106, and a second spectrum of visible light, different than the first spectrum. The illuminators may be outward-facing illuminators on the device. Accordingly, an image may be captured of the environment while the illuminators are activated and producing light in a spectrum not visible to the user. The device may determine, based on the image data, a region of interest in the environment. The device may then activate one or more additional illuminators in a visible light spectrum toward the region of interest such that the region of interest becomes visible, or increases in visibility, to the user. For example, a secondary illuminator on device 102 which produces visible light may be activated. Additionally, or alternatively, the device 102 may trigger other light sources in the environment, such as lamp 104 if the lamp 104 is communicably coupled to the device 102. In some embodiments, the particular illuminator (or illuminators) activated may be based on a spatial relationship between the device 102 (or illuminators on the device 102), and the region of interest. That is, the device 102 can intelligently activate illuminators in the direction of the region of interest, thereby reducing resource consumption by not activating unnecessary illuminators.

In one or more embodiments, the device 102 can intelligently illuminate an environment to bring attention to obstructions or unexpected objects in a physical environment. For example, the device may have access to predefined mapping data of a physical environment 100, such as a point cloud, three dimensional model, or other geometric representation of the environment 100. A determination can be made as to whether the environment includes an object of interest. The object of interest may include, for example, an obstruction in the vicinity of the user as indicated by the mapping data, or an object or obstruction in the vicinity of the user which is not identified in the mapping data and therefore is unexpected. For example, if the environment 100 was darkened, and the user was walking toward the desk 126, the device may trigger illuminators toward the desk 126 to bring attention to the desk. For example, the device 102 may activate illuminators on the device 102, or on a remote device in the environment, such as the lamp 104. In some embodiments, the device 102 may generate a notification or other visual indication for presentation on the display 110 in the vicinity of the view of the desk 126 such that the user is made aware of the desk.

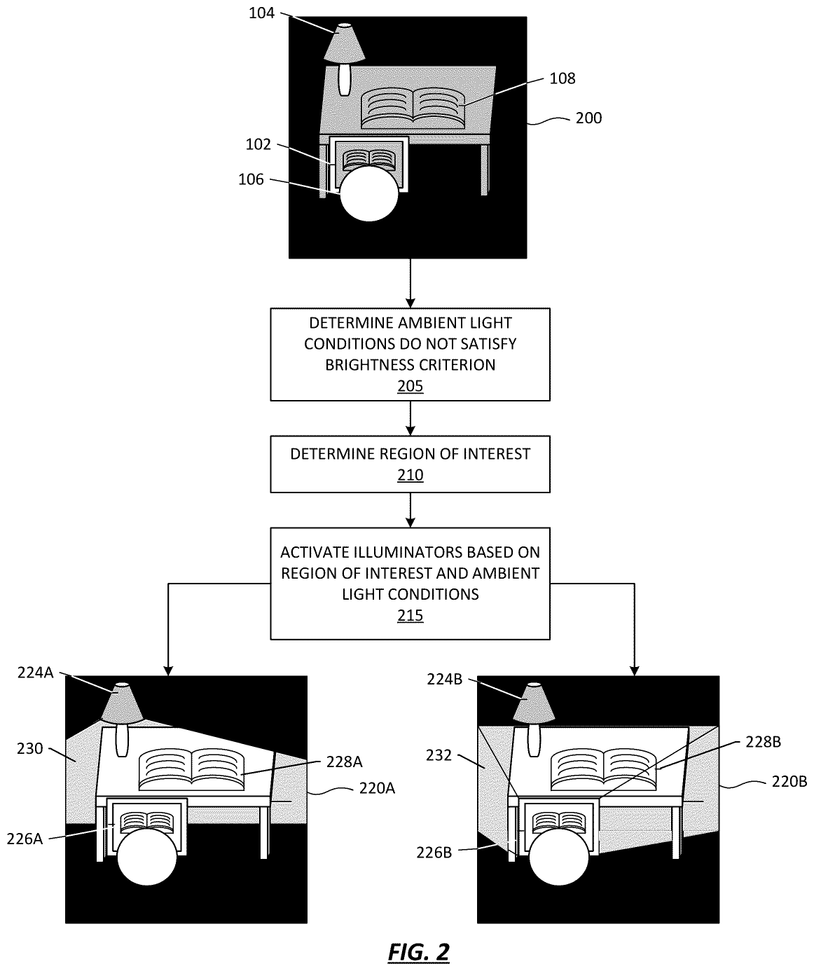

Turning now to FIG. 2, a flow diagram is presented of a technique for managing an operation of a device to intelligently activate illuminators, according to one or more embodiments. The flow diagram begins at 200, showing an alternate view of the environment 100 of FIG. 1. As such, 200 shows that the user 106 is viewing the book 108 in a dark room. The user 106 is reading the book via device 102, which can include a see-through display such that the book 108 is visible to the user through the device 102.

The flow diagram continues at block 205 where ambient light conditions are determined. According to one or more embodiments, the ambient light conditions may be determined based on ambient light levels reported from an ambient light system of the device. According to one or more embodiments, a determination is made as to whether the device is in a low light environment based on the determined ambient light conditions. For example, a determination may be made that the ambient light conditions do not satisfy a predefined brightness criterion. The brightness criterion may be defined, for example, as a single predefined brightness value, or may be based on a context of the user or device. For example, a brightness criterion used by the device in an outdoor environment may differ than a brightness criterion in an indoor environment. Further, the brightness criterion may be user-defined or may change dynamically based on conditions of the environment or device.

According to some embodiments, a region of interest is determined in the environment, as shown at block 210. The region of interest may be determined in a number of ways. For example, the region of interest may be defined based on a portion of the environment having an obstruction or unexpected object based on predefined mapping data for the environment. As another example, a region of interest may be determined based on sensor data captured at the region, such as by a depth sensor, image sensor, or the like.

The flowchart continues to block 215 where, based on the ambient light conditions and/or the region of interest, particular illuminators are activated. As described above, the corrective operation may be performed by the local device and/or by directing one or more additional devices to perform the operation. The illumination operation may thereby cause a chance in ambient light of the environment. According to one or more embodiments, the illuminators activated may be based on the spatial relationship between the illuminators and the object of interest. Additionally, or alternatively, the illuminators activated may be selected based on head pose of a user wearing the device.

Additional considerations may be used in selecting illuminators to activate. For example, if one or more additional people are detected in the environment, illuminators may be activated to avoid the people in the environment, such that the light is not shining directly at the other people in the environment. As another example, the illuminators may be activated to match a color temperature of the ambient light.

In some embodiments, as shown at 220A, the device 226A may cause a lamp 224A to be activated or turned on such that the book 228A is lit 230 in the environment. For example, lamp 224A may be part of a connected “smart home” network which can be operated from the device 226A. As another example, as shown at 220B, the device 226B may engage an external-facing illuminator 232 comprised in the device to light the book 228B, such that the book 228B is lit in the environment while the lamp 224B remains turned off. In some embodiments, a combination of illuminators on the device and remotely can be used. Upon activating the illuminators, the book 228B becomes more visible than initially presented at 200.

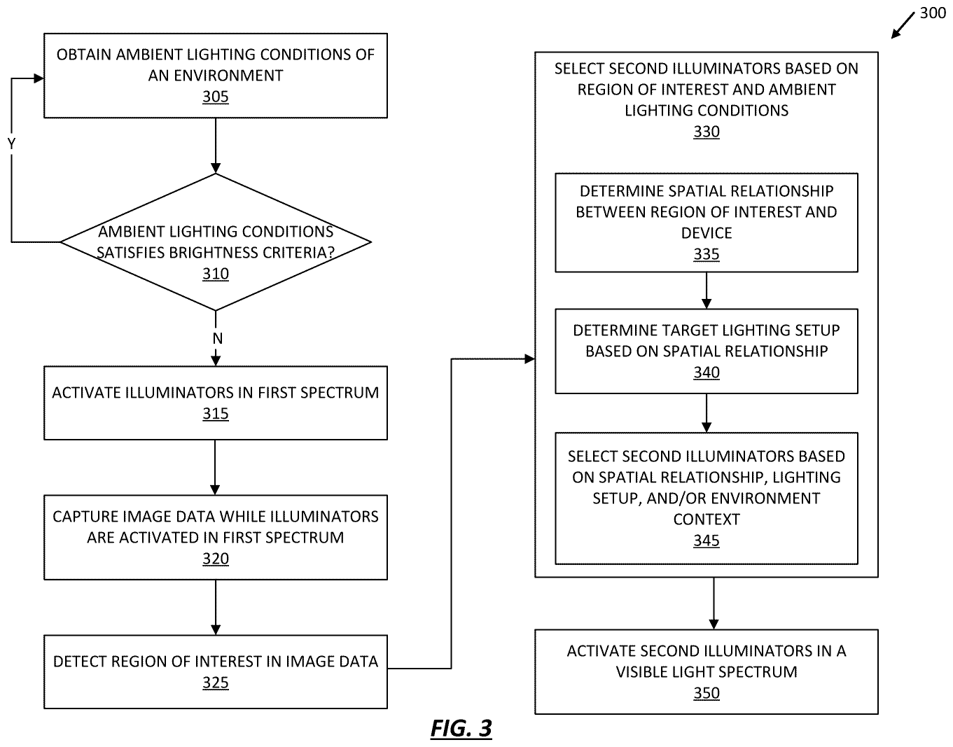

FIG. 3 shows, in flowchart form, an example process for an illumination operation based ambient light conditions. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added, according to various embodiments.

The flowchart 300 begins at block 305 ambient lighting conditions of an environment are obtained from environment sensor data. The environment sensor data may include data from sensors on the local device or be obtained from sensors on remote devices, in some embodiments. The sensors may be embedded in the device and may include sensors, such as cameras, ambient light sensors, microphones, flicker sensors, and the like.

At block 310, a determination is made as to whether the ambient lighting conditions satisfies a brightness criterion. The brightness criterion may be defined, for example, as a single predefined brightness value, or may be based on a context of the user or device. For example, a brightness criterion used by the device in an outdoor environment may differ than a brightness criterion in an indoor environment. Further, the brightness criterion may be user-defined or may change dynamically based on conditions of the environment or device. If the ambient lighting conditions satisfy a brightness criterion, then no other action is taken and the flowchart 300 returns to block 305 and the device continues to track ambient lighting conditions.

Returning to block 310, if a determination is made that the ambient lighting conditions fail to satisfy a brightness threshold, then the flowchart proceeds to block 315. At block 315, illuminators on the device are activated in a first spectrum. For example, the illuminators may be outward-facing illuminators and produce light in a first spectrum not visible to a user. As an example, the illuminators may include infrared (IR) lights which are not visible to a human. According to one or more embodiments the illuminators may be selected which face a same direction as the user, or may flood the environment.

The flowchart 300 proceeds to block 320, where image data is captured while the illuminators are activated in a first spectrum. According to one or more embodiments, capturing the image data may include activating one or more computer vision cameras or other computer vision processors on the device. That is, images captured using infrared light may allow for object detection without the need to illuminate the environment with visible light.

At block 325, a region of interest is detected in the image data. According to one or more embodiments, the region of interest in the environment may be determined by using computer vision to determine objects or classifications of objects in the environment, such as walls, furniture or the like. In some embodiments, the region of interest may additionally, or alternatively, be determined based on a head pose. For example, motion capturing sensor in the device can be used to determine a pose of the device and, therefore, a direction the user is facing. The head pose data can therefor be used to determine a region of the environment the user is facing.

The flowchart proceeds to block 330, where second illuminators are selected based on the region of interest and ambient lighting conditions. The second illuminators may be selected to illuminate the region of interest and may be selected based on a number of considerations. At block 335, a spatial relationship is determined between the region of interest and the device. In one or more embodiments, the spatial relationship may be determined based on a relative direction between the illuminators on the device and the region of interest. In some embodiments, an orientation of the device may also be considered. For example, if the device is tilted downward, then the user is likely looking down, and the illuminators can be activated to provide light in a downward direction.

The flowchart continues to block 340, where a target lighting setup is determined based on the spatial relationship. In one or more embodiments, the target lighting setup may include a subset of available illuminators on device and/or in the environment, a temperature of the light, a brightness of the light, and the like. For example, a target lighting temperature may be selected to match a lighting temperature detected by the ambient light sensor. As another example, a target brightness may be determined. The target brightness may be dependent on context, for example. As an example, during the day a target brightness may differ than at night. As another example, a target brightness may be location specific. Thus, the target brightness at home may be brighter than a target brightness in a public location to avoid unintentionally interrupting others in the environment with excess light. As another example, the target lighting setup may be based on user context. For example, if a user activity is detected using fine motor skills, such as threading a needle, then a brighter light may be provided than if the user were simply navigating a dark environment.

At block 345, the second illuminators are selected based on the spatial relationship, lighting setup, and/or environment context. That is, one or more illuminators may be selected based on the region of interest and relative position of the device, and characteristics of the illuminators may be selected for activation based on the target parameters. According to one or more embodiments, the illuminators may be selected from among available illuminators on the device and/or illuminators in the environment which can be activated by the device.

In one or more embodiments, the device may communicate with other devices in the environment which also have illuminators. According to one or more embodiments, two or more head mounted devices integrated with illuminators may be in a same environment, such as two people using separate systems in a room. In this embodiment, the two devices could communicate location information with each other to cooperatively determine a lighting setup. Accordingly, one or more illuminators on the second device may be selected. In some embodiments, the one or more illuminators on the second device are selected based on a head pose or device orientation of the local device, a head pose or device orientation of the second device, and a region of interest.

The flowchart 300 concludes at 350 where the second illuminators are activated in a visible light spectrum. In some embodiments, the device includes a see-through or transparent display. Upon activation of the second illuminators projecting visible light, the surrounding environment may become more visible to a user through the see-through or transparent display.

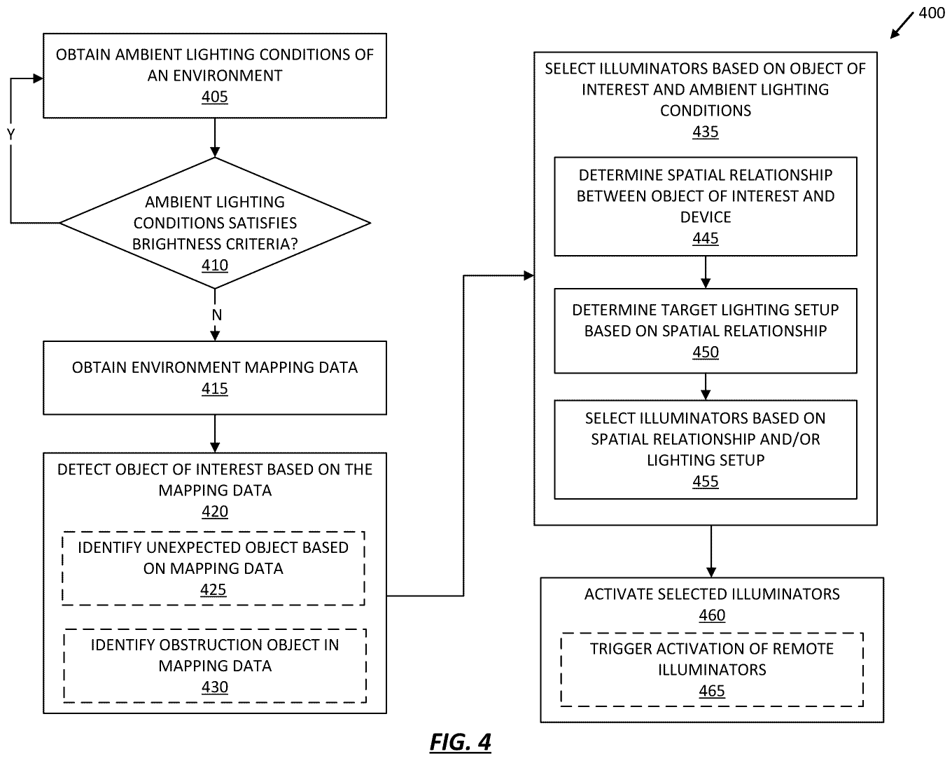

In one or more embodiments, the system can intelligently illuminate an environment to bring attention to obstructions or unexpected objects in a physical environment by leveraging data regarding the environment. FIG. 4 shows, in flowchart form, an example process for performing an illumination operation based on ambient light conditions and an object of interest, in accordance with one or more embodiments. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added, according to various embodiments.

The flowchart 400 begins at block 405 ambient lighting conditions of an environment are obtained from environment sensor data. The environment sensor data may include data from sensors on the local device or be obtained from sensors on remote devices, in some embodiments. The sensors may be embedded in the device and may include sensors, such as cameras, ambient light sensors, microphones, flicker sensors, and the like.

At block 410, a determination is made as to whether the ambient lighting conditions satisfies a brightness criterion. The brightness criterion may be defined, for example, as a single predefined brightness value, or may be based on a context of the user or device. For example, a brightness criterion used by the device in an outdoor environment may differ than a brightness criterion in an indoor environment. Further, the brightness criterion may be user-defined or may change dynamically based on conditions of the environment or device. If the ambient lighting conditions satisfy a brightness criterion, then no other action is taken and the flowchart 400 returns to block 405 and the device continues to track ambient lighting conditions.

Returning to block 410, if a determination is made that the ambient lighting conditions fail to satisfy a brightness threshold, then the flowchart proceeds to block 415. At block 415, environment mapping data is obtained. According to one or more embodiments, the environment mapping data may include data related to a layout of an environment. As an example, a point cloud, mesh, or the like can be used to indicate the relative positioning of walls, floors, and objects in the environment. As an example, the environment may have been previously scanned and enrolled as a known environment by a device. The head mounted device may have access to the environment mapping data, for example, from cloud storage or the like.

The flowchart proceeds to block 420, and an object of interest is detected based on the mapping data. The object of interest may be any object detected in the environment which should be highlighted to the user using one or more illuminators. As an example, as shown in optional block 425, detecting an object of interest can include identifying an unexpected object base on the mapping data. For example, a depth sensor or camera may indicate that an object in the environment at a location in the environment where an object is not expected in accorance with the mapping data. That is, localization information for the device can be determined and compared against the environment mapping data to determine expected objects in the environment.

Additionally, or alternatively, as shown at optional block 430, an obstruction may be identified based on the mapping data. For example, localization information for the device can be determined and compared against the environment mapping data to determine whether a user is approaching an obstruction, such as a wall or object present in the mapping data.

A determination can be made as to whether the environment includes an object of interest. The object of interest may include, for example, an obstruction in the vicinity of the user as indicated by the mapping data, or an object or obstruction in the vicinity of the user which is not identified in the mapping data and therefore is unexpected. The device may trigger illuminators toward the object of interest to bring attention to the object of interest.

The flowchart proceeds to block 435, where illuminators are selected based on the object of interest and ambient lighting conditions. The illuminators may be selected to illuminate the object of interest and may be selected based on a number of considerations. At block 445, a spatial relationship is determined between the object of interest and the device. In one or more embodiments, the spatial relationship may be determined based on a relative direction between the illuminators on the device and the object of interest. In some embodiments, an orientation of the device may also be considered. For example, if the device is tilted in a direction toward a particular portion of the object of interest, the direction can be determined based on pose information for the device.

The flowchart continues to block 450, where a target lighting setup is determined based on the spatial relationship. In one or more embodiments, the target lighting setup may include a subset of available illuminators on device and/or in the environment, a temperature of the light, a brightness of the light, and the like. For example, a target lighting temperature may be selected to match a lighting temperature detected by the ambient light sensor. As another example, a target brightness may be determined. The target brightness may be dependent on context, for example. As an example, during the day a target brightness may differ than at night. As another example, a target brightness may be location specific. Thus, the target brightness at home may be brighter than a target brightness in a public location to avoid unintentionally interrupting others in the environment with excess light.

At block 455, the illuminators are selected based on the spatial relationship, lighting setup, and/or environment context. That is, one or more illuminators may be selected based on the region of interest and relative position of the device, and characteristics of the illuminators may be selected for activation based on the target parameters. According to one or more embodiments, the illuminators may be selected from among available illuminators on the device and/or illuminators in the environment which can be activated by the device.

The flowchart 400 concludes at 460 where the illuminators are activated in accordance with the selection. Optionally, at block 465, the device triggers activation of remote illuminators. For example, the device may be part of a connected “smart home” network which can be operated from the device. Further, in one or more embodiments, the device may communicate with other devices in the environment which also have illuminators. According to one or more embodiments, two or more head mounted devices integrated with illuminators may be in a same environment, such as two people using separate systems in a room. In this embodiment, the two devices could communicate location information with each other to cooperatively determine and execute a lighting setup. Other remote devices having illuminators may thus be communicably connected to the device and, therefore, could be activated remotely, for example from the head mounted device. In some embodiments, the device includes a see-through display. Upon activation of the illuminators, the object of interest may become more visible to a user through the see-through display.

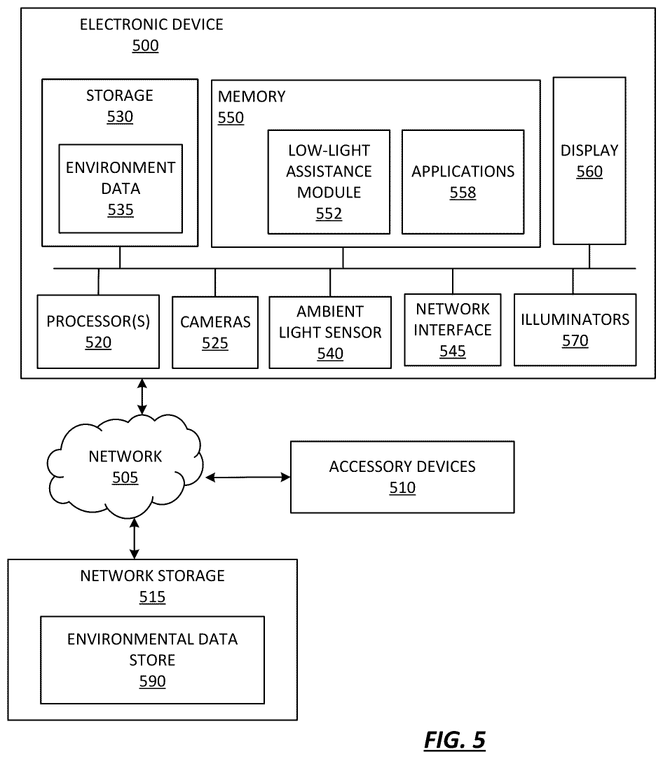

FIG. 5 depicts a network diagram for a system by which various embodiments of the disclosure may be practiced. Specifically, FIG. 5 depicts an electronic device 500 that is a computer system. Electronic device 500 may be part of a multifunctional device, such as a mobile phone, tablet computer, personal digital assistant, portable music/video player, wearable device, head mounted systems, projection-based systems, base station, laptop computer, desktop computer, network device, or any other electronic system such as those described herein. Electronic device 500 may be connected to other devices across a network 505, such as an accessory electronic device 510, mobile devices, tablet devices, desktop devices, and remote sensing devices, as well as network storage 515. Accessory devices 510 may include, for example, additional laptop computers, desktop computers, mobile devices, wearable devices and other devices communicably coupled to electronic device 500. In some embodiments, accessory devices 510 may include IoT devices communicably coupled to the electronic device 500 and having one or more sensors by which environmental data can be captured and/or one or more illuminators which can be triggered by the electronic device 500. Network storage 515 may be any kind of electronic device communicably coupled to electronic device 500 across network 505 via network interface 545. In some embodiments, network storage 515 may include cloud storage and the like. Network 505 may include one or more types of networks across which the various electronic components are communicably coupled. Illustrative networks include, but are not limited to, a local network, such as a universal serial bus (USB) network, an organization's local area network, and a wide area network, such as the Internet.

Electronic device 500, accessory electronic devices 510, and/or network storage 515 may additionally or alternatively include one or more additional devices within which the various functionality may be contained or across which the various functionality may be distributed, such as server devices, base stations, accessory devices, and the like. It should be understood that the various components and functionality within electronic device 500, additional electronic device 510, and network storage 515 may be differently distributed across the devices or may be distributed across additional devices.

Electronic device 500 may include a processor 520. Processor 520 may be a system-on-chip, such as those found in mobile devices, and include one or more central processing units (CPUs), dedicated graphics processing units (GPUs), or both. Further, processor 520 may include multiple processors of the same or different type. Electronic device 500 may also include a memory 550. Memory 550 may include one or more different types of memory which may be used for performing device functions in conjunction with processor 520. For example, memory 550 may include cache, ROM, RAM, or any kind of transitory or non-transitory computer readable storage medium capable of storing computer readable code. Memory 550 may store various programming modules during execution, such as low light assistance module, which is configured to detect low light conditions via sensors data captured, for example, by the ambient light sensor 540. In some embodiments, low-light assistance module 552 may determine a lighting setup and trigger activation of local illuminators 570 and remote illuminators accordingly. Further, memory 550 may include one or more additional applications 558. In some embodiments, a state of the applications 558 may be used by the low light assistance module 552 to determine user activity, device context, and the like. In some embodiments, context is determined based on image data captured by cameras 525.

Electronic device 500 may also include storage 530. Storage 530 may include one or more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 530 may be utilized to store various data and structures which may be utilized for mitigating triggering conditions in a pass-through environment. For example, storage 530 may include environment data store 535 which may include predefined geometric and/or layout information for one or more physical environments. Additionally, or alternatively, the environment data may be stored remotely, for example, as environmental data store 590 of network storage 515.

Electronic device 500 may allow a user to interact with XR environments. Many electronic systems enable an individual to interact with and/or sense various XR settings. One example includes head mounted systems. A head mounted system may have an opaque display and speaker(s). Alternatively, a head mounted system may be designed to receive an external display (e.g., a smartphone). The head mounted system may have imaging sensor(s) and/or microphones for taking images/video and/or capturing audio of the physical setting, respectively. A head mounted system also may have a transparent or semi-transparent see-through display 560. The transparent or semi-transparent display may incorporate a substrate through which light representative of images is directed to an individual's eyes. The display may incorporate LEDs, OLEDs, a digital light projector, a laser scanning light source, liquid crystal on silicon, or any combination of these technologies. The substrate through which the light is transmitted may be a light waveguide, optical combiner, optical reflector, holographic substrate, or any combination of these substrates. In one embodiment, the transparent or semi-transparent display may transition selectively between an opaque state and a transparent or semi-transparent state. In another example, the electronic system may be a projection-based system. A projection-based system may use retinal projection to project images onto an individual's retina. Alternatively, a projection system also may project virtual objects into a physical setting (e.g., onto a physical surface or as a holograph). Other examples of XR systems include heads up displays, automotive windshields with the ability to display graphics, windows with the ability to display graphics, lenses with the ability to display graphics, headphones or earphones, speaker arrangements, input mechanisms (e.g., controllers having or not having haptic feedback), tablets, smartphones, and desktop or laptop computers.

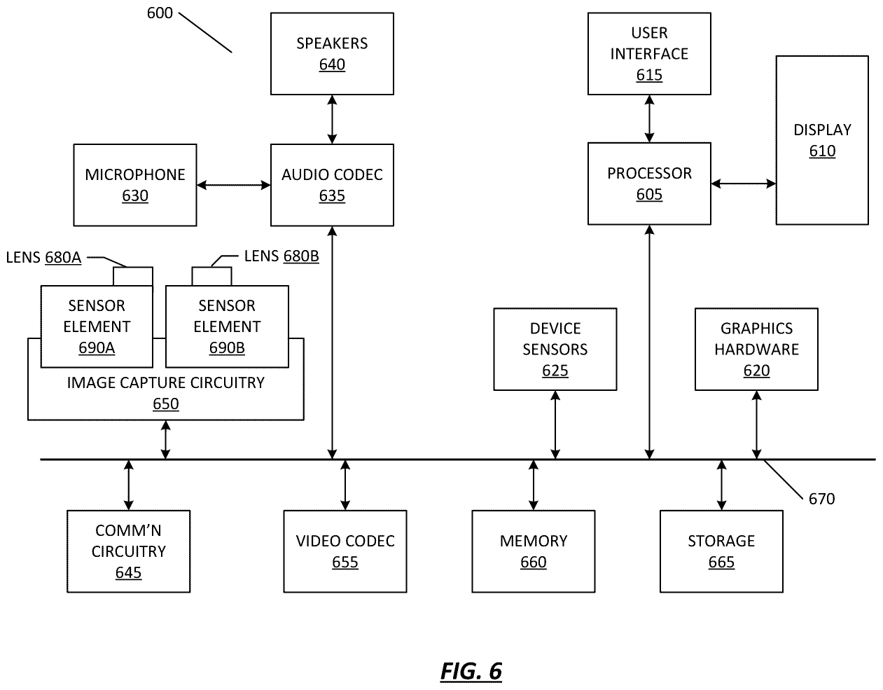

Referring now to FIG. 6, a simplified functional block diagram of illustrative multifunction electronic device 600 is shown according to one embodiment. Each of electronic devices may be a multifunctional electronic device or may have some or all of the components of a multifunctional electronic device described herein. Multifunction electronic device 600 may include some combination of processor 605, display 610, user interface 615, graphics hardware 620, device sensors 625 (e.g., proximity sensor/ambient light sensor, accelerometer and/or gyroscope), microphone 630, audio codec 635, speaker(s) 640, communications circuitry 645, digital image capture circuitry 650 (e.g., including camera system), memory 660, storage device 665, and communications bus 670. Multifunction electronic device 600 may be, for example, a mobile telephone, personal music player, wearable device, tablet computer, or the like.

Processor 605 may execute instructions necessary to carry out or control the operation of many functions performed by device 600. Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen, touch screen, and the like. Processor 605 may also, for example, be a system-on-chip, such as those found in mobile devices, and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include one or more lens assemblies, such as 680A and 680B. The lens assemblies may have a combination of various characteristics, such as differing focal length and the like. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still images, video images, enhanced images, and the like. Output from image capture circuitry 650 may be processed, at least in part, by video codec(s) 655, processor 605, graphics hardware 620, and/or a dedicated image processing unit or pipeline incorporated within circuitry 645. Images so captured may be stored in memory 660 and/or storage 665.

Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image, and video files), computer program instructions or software, preference information, device profile information, and any other suitable data. Storage 665 may include one more non-transitory computer-readable storage mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Memory 660 and storage 665 may be used to tangibly retain computer program instructions or computer readable code organized into one or more modules and written in any desired computer programming language. When executed by, for example, processor 605, such computer program code may implement one or more of the methods described herein.

There are many different types of electronic systems that enable a person to sense and/or interact with various XR environments. Examples include: head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 3-4, or the arrangement of elements shown in FIGS. 1-2 and 5-6, should not be construed as limiting the scope of the disclosed subject matter. The scope of the invention, therefore, should be determined with reference to the appended claims, along with the full scope of equivalents to which such claims are entitled. In the appended claims, the terms “including” and “in which” are used as the plain English equivalents of the respective terms “comprising” and “wherein.”

1. A method, comprising:
receiving, at a head mounted device, information indicative of ambient lighting conditions in an environment,
in accordance with a determination that the ambient lighting conditions do not satisfy a brightness criterion:
activating one or more first illuminators on the head mounted device to project light in a first spectrum;
while the one or more first illuminators are activated, capturing image data of the environment;
determining a region of interest in the environment based on the captured image data; and
activating a second one or more illuminators to project light in a visible light spectrum different than the first spectrum.

2. The method of claim 1, wherein the second one or more illuminators are selected from a plurality of outward facing illuminators based on a spatial relationship between the head mounted device and the region of interest and the ambient lighting conditions.

3. The method of claim 1, wherein the environment is visible through a transparent display of the head mounted device.

4. The method of claim 1, wherein activating the second one or more illuminators comprises:
determining a remote device comprising the second one or more illuminators based on the region of interest; and
triggering the remote device to activate the second one or more illuminators.

5. The method of claim 1, wherein the activating the second one or more illuminators comprises:
detecting one or more people in the environment; and
selecting the second one or more illuminators to avoid illuminating the one or more people in the environment.

6. The method of claim 1, wherein a first at least one of the second one or more illuminators are comprised in the head mounted device.

7. The method of claim 6, wherein a second at least one of the second one or more illuminators are comprised in a second head mounted device, and
wherein the activating the second one or more illuminators comprises:
determining, based on the region of interest, a lighting setup comprising the first at least one of the second one or more illuminators and the second at least one of the second one or more illuminators;
activating the second at least one of the second one or more illuminators; and
triggering the second head mounted device to activate the first at least one of the second one or more illuminators.

8. A non-transitory computer readable medium comprising computer readable code executable by one or more processors to:
receive, at a head mounted device, information indicative of ambient lighting conditions in an environment,
in accordance with a determination that the ambient lighting conditions do not satisfy a brightness criterion:
activate one or more first illuminators on the head mounted device to project light in a first spectrum;
while the one or more first illuminators are activated, capture image data of the environment;
determine a region of interest in the environment based on the captured image data; and
activate a second one or more illuminators to project light in a visible light spectrum different than the first spectrum.

9. The non-transitory computer readable medium of claim 8, wherein the second one or more illuminators are selected from a plurality of outward facing illuminators based on a spatial relationship between the head mounted device and the region of interest and the ambient lighting conditions.

10. The non-transitory computer readable medium of claim 8, wherein the environment is visible through a transparent display of the head mounted device.

11. The non-transitory computer readable medium of claim 8, wherein the computer readable code to activate the second one or more illuminators comprises computer readable code to:
determine a remote device comprising the second one or more illuminators based on the region of interest; and
trigger the remote device to activate the second one or more illuminators.

12. The non-transitory computer readable medium of claim 8, wherein the computer readable code to activate the second one or more illuminators comprises computer readable code to:
detect one or more people in the environment; and
select the second one or more illuminators to avoid illuminating the one or more people in the environment.

13. The non-transitory computer readable medium of claim 8, wherein a first at least one of the second one or more illuminators are comprised in the head mounted device.

14. The non-transitory computer readable medium of claim 13, wherein a second at least one of the second one or more illuminators are comprised in a second head mounted device, and wherein the wherein the computer readable code to activate the second one or more illuminators comprises computer readable code to:
determine, based on the region of interest, a lighting setup comprising the first at least one of the second one or more illuminators and the second at least one of the second one or more illuminators;
activate the second at least one of the second one or more illuminators; and
trigger the second head mounted device to activate the first at least one of the second one or more illuminators.

15. A system comprising:
one or more processors; and
one or more computer readable medium comprising computer readable code executable by the one or more processors to:
receive, at a head mounted device, information indicative of ambient lighting conditions in an environment,
in accordance with a determination that the ambient lighting conditions do not satisfy a brightness criterion:
activate one or more first illuminators on the head mounted device to project light in a first spectrum;
while the one or more first illuminators are activated, capture image data of the environment;
determine a region of interest in the environment based on the captured image data; and
activate a second one or more illuminators to project light in a visible light spectrum different than the first spectrum.

16. The system of claim 15, wherein the second one or more illuminators are selected from a plurality of outward facing illuminators based on a spatial relationship between the head mounted device and the region of interest and the ambient lighting conditions.

17. The system of claim 15, wherein the environment is visible through a transparent display of the head mounted device.

18. The system of claim 15, wherein the computer readable code to activate the second one or more illuminators comprises computer readable code to:
determine a remote device comprising the second one or more illuminators based on the region of interest; and
trigger the remote device to activate the second one or more illuminators.

19. The system of claim 15, wherein the computer readable code to activate the second one or more illuminators comprises computer readable code to:
detect one or more people in the environment; and
select the second one or more illuminators to avoid illuminating the one or more people in the environment.

20. The system of claim 15, wherein a first at least one of the second one or more illuminators are comprised in the head mounted device.
